(19) United States
(12) Patent Application Publication
(10) Pub. No.: US 2008/0240246 A1
(43) Pub. Date: Oct. 2, 2008

(54) VIDEO ENCODING AND DECODING METHOD AND APPARATUS

(75) Inventors: Sang-rae LEE, Suwon-si (KR); Woo-jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/027,410

(22) Filed: Feb. 7, 2008

(30) Foreign Application Priority Data
Mar. 28, 2007 (KR) 10-2007-0030374

(51) Int. Cl. H04N 7/12

(52) U.S. Cl. 375/240.16; 375/240.24; 375/240.12; 375/E07.125; 375/E07.258

(57) ABSTRACT

Provided are a video encoding and decoding method and apparatus, in which a current block is divided into partitions based on an edge in the current block, and motion estimation is performed on the divided partitions. Video encoding efficiency can be improved by encoding partitions that are obtained by dividing the current block along a predetermined line passing through pixels belonging to an edge around the current block from among neighboring pixels around the current block.

### CROSS-REFERENCE TO RELATED PATENT APPLICATION

This application claims priority from Korean Patent Application No. 10-2007-0030374, filed on Mar. 28, 2007, in the Korean Intellectual Property Office, the disclosure of which is incorporated herein in their entirety by reference.

### BACKGROUND OF THE INVENTION

1. Field of the Invention

The present invention relates to a video encoding and decoding method and apparatus, in which a block is divided into partitions based on an edge direction and the divided partitions are encoded, and more particularly, to a video encoding and decoding method and apparatus, in which pixels belonging to an edge of a current block are detected from among neighboring pixels that are adjacent to the current block, the current block is divided into partitions using the detected neighboring pixels belonging to the edge of the current block, and motion estimation is performed on the divided partitions.

2. Description of the Related Art

In video compression standards such as moving picture expert group (MPEG)-1, MPEG-2, and H.264/MPEG-4 advanced video coding (AVC), pictures are generally divided into macroblocks for video encoding. After each of the macroblocks is encoded in each of the interprediction and intraprediction encoding modes available, an appropriate encoding mode is selected according to the bit rate required for encoding the macroblocks and distortion between the original macroblocks and the decoded macroblocks. Then the macroblocks are encoded in the selected encoding mode.

In interprediction, a motion vector is generated by searching for a region that is similar to the current block to be encoded, in at least one reference picture that precedes or follows the current picture to be encoded. A differential value between a prediction block generated by motion compensation using the generated motion vector, and the current block is then encoded.

FIG. 1 illustrates conventional block modes for motion estimation/compensation. Referring to FIG. 1, a 16×16 macroblock can be divided into two 16×8 blocks, two 8×16 blocks, or four 8×8 blocks for motion estimation/compensation. Each of the 8×8 blocks may be further divided into two 4×8 blocks, two 8×4 blocks, or four 4×4 blocks for motion estimation/compensation.

According to the related art, a prediction block is generated by performing motion estimation/compensation using blocks of various sizes as illustrated in FIG. 1. A residual block corresponding to a differential value between the generated prediction block and the original block is encoded, and a block mode having the best encoding efficiency is selected as a final block mode.

FIG. 2 illustrates division of a macroblock having an edge according to the related art.

If a macroblock includes an edge as illustrated in FIG. 2, a 16×8 block mode that divides the macroblock in a direction that is similar to the direction of the edge may be selected from among the conventional block modes illustrated in FIG. 1. In this case, since an upper 16×8 sub-block has an edge that is a high-frequency component, its encoding efficiency deteriorates.

According to the related art, a macroblock is divided into fixed-shape partitions as illustrated in FIG. 1 for interprediction. As a result, a macroblock having an edge cannot be divided along the direction of the edge. For this reason, a high-frequency component of a sub-block including the edge increases, thereby degrading encoding efficiency.

### SUMMARY OF THE INVENTION

The present invention provides a video encoding and decoding method and apparatus, in which an edge in a current block is predicted using neighboring pixels that are adjacent to the current block and the current block is divided into partitions along the direction of the predicted edge for encoding, thereby improving encoding efficiency.

The present invention also provides a video encoding and decoding method and apparatus, in which edge information included in a current block is efficiently transmitted without increasing overhead.

According to an aspect of the present invention, there is provided a video encoding method including detecting pixels belonging to an edge from among neighboring pixels that are adjacent to a current block to be encoded; dividing the current block into partitions along a line that passes through the detected pixels belonging to the edge and is expressed as a predetermined polynomial function; and encoding the divided partitions of the current block.

According to another aspect of the present invention, there is provided a video encoding apparatus including an edge detection unit detecting pixels belonging to an edge from among neighboring pixels that are adjacent to a current block to be encoded; a division unit dividing the current block into partitions along a line that passes through the detected pixels belonging to the edge of the current block and is expressed as a predetermined polynomial function; and an encoding unit encoding the divided partitions of the current block.

According to another aspect of the present invention, there is provided a video decoding method including extracting information on positions of pixels belonging to an edge from among neighboring pixels that are adjacent to a current block and information on a line that passes through the pixels belonging to the edge around the current block and divides the current block from a received bitstream; dividing the current block into partitions using the extracted information on the positions of the pixels belonging to the edge around the current block and the extracted information on the line; performing motion compensation on the divided partitions, thereby generating prediction partitions; adding the prediction partitions to a residue included in the bitstream, thereby reconstructing the partitions of the current block; and combining the reconstructed partitions, thereby decoding the current block.

According to another aspect of the present invention, there is provided a video decoding method including determining a corresponding block of a reference frame referred to by a current block to be decoded using information on a motion vector of the current block; detecting pixels belonging to an edge around the determined corresponding block from among neighboring pixels that are adjacent to the determined corresponding block; determining neighboring pixels that are adjacent to the current block, which correspond to the detected pixels belonging to the edge around the determined corresponding block, as belonging to an edge around the current block; dividing the current block into partitions along the determined neighboring pixels belonging to the edge around the current block; performing motion compensation on the divided partitions using information on motion vectors of the divided partitions, which is included in the bitstream, thereby generating prediction partitions; adding the prediction partitions to a residue included in the bitstream, thereby reconstructing the partitions of the current block; and combining the reconstructed partitions, thereby decoding the current block.

According to another aspect of the present invention, there is provided a video decoding apparatus including an edge detection unit extracting information on positions of pixels belonging to an edge from among neighboring pixels that are adjacent to a current block and information on a line that passes through the pixels belonging to the edge around the current block and divides the current block from a received bitstream; a division unit dividing the current block into partitions using the extracted information on the positions of the pixels belonging to the edge around the current block and the extracted information on the line; a motion compensation unit performing motion compensation on the divided partitions, thereby generating prediction partitions; an addition unit adding the prediction partitions to a residue included in the bitstream, thereby reconstructing the partitions of the current block; and a combination unit combining the reconstructed partitions, thereby decoding the current block.

According to another aspect of the present invention, there is provided a video decoding apparatus including an edge detection unit determining a corresponding block of a reference frame referred to by a current block to be decoded using information on a motion vector of the current block, detecting pixels belonging to an edge around the determined corresponding block from among neighboring pixels that are adjacent to the determined corresponding block, and determining neighboring pixels that are adjacent to the current block, which correspond to the detected pixels belonging to the edge around the determined corresponding block, as belonging to an edge around the current block; a division unit dividing the current block into partitions along the determined neighboring pixels belonging to the edge around the current block; a motion compensation unit performing motion compensation on the divided partitions using information on motion vectors of the divided partitions, which is included in the bitstream, thereby generating prediction partitions; an addition unit adding the prediction partitions to a residue included in the bitstream, thereby reconstructing the partitions of the current block; and a combining unit combining the reconstructed partitions, thereby decoding the current block.

### BRIEF DESCRIPTION OF THE DRAWINGS

The above and other features and advantages of the present invention will become more apparent from the following detailed description of exemplary embodiments thereof with reference to the attached drawings in which:

FIG. 1 illustrates block modes for a related art motion estimation/compensation technique;

FIG. 2 illustrates division of a macroblock having an edge according to the related art;

FIG. 3 is a block diagram of a video encoding apparatus according to an exemplary embodiment of the present invention;

FIG. 4 is a view for explaining an example of division of a current block using neighboring pixels belonging to an edge of the current block, according to an exemplary embodiment of the present invention;

FIG. 5 is a view for explaining an example of detection of pixels belonging to an edge of a current block from among neighboring pixels that are adjacent to the current block, according to an exemplary embodiment of the present invention;

FIG. 6 is a view for explaining an example of detection of pixels belonging to an edge of a current block using neighboring pixels of the current block, according to an exemplary embodiment of the present invention;

FIG. 7 illustrates edge directions used for division of a current block according to an exemplary embodiment of the present invention;

FIG. 8 is a view for explaining an example of division of a current block using detected neighboring pixels belonging to an edge as illustrated in FIG. 6, according to an exemplary embodiment of the present invention;

FIGS. 9A to 9C illustrate other examples of division of a current block using neighboring pixels belonging to an edge of the current block, according to exemplary embodiments of the present invention;

FIG. 10 is a view for explaining another example of detection of pixels belonging to an edge of a current block from among neighboring pixels that are adjacent to the current block, according to an exemplary embodiment of the present invention;

FIG. 11 is a flowchart of a video encoding method according to an exemplary embodiment of the present invention;

FIG. 12 is a block diagram of a video decoding apparatus according to an exemplary embodiment of the present invention;

FIG. 13 is a flowchart of a video decoding method according to an exemplary embodiment of the present invention; and

FIG. 14 is a flowchart of a video decoding method according to another exemplary embodiment of the present invention.

### DETAILED DESCRIPTION OF EXEMPLARY EMBODIMENTS OF THE INVENTION

Hereinafter, exemplary embodiments of the present invention will be described in detail with reference to the accompanying drawings. In the drawings, like reference numerals refer to like elements illustrated in one or more of the drawings. In the following description of exemplary embodiments of the present invention, a detailed description of known functions and configurations incorporated herein will be omitted for conciseness and clarity.

A video encoding apparatus according to an exemplary embodiment of the present invention detects a pixel that is likely to belong to an edge of a current block from among neighboring pixels that are adjacent to the current block, divides the current block into partitions by a predetermined line around the detected pixel, and encodes each of the generated partitions.

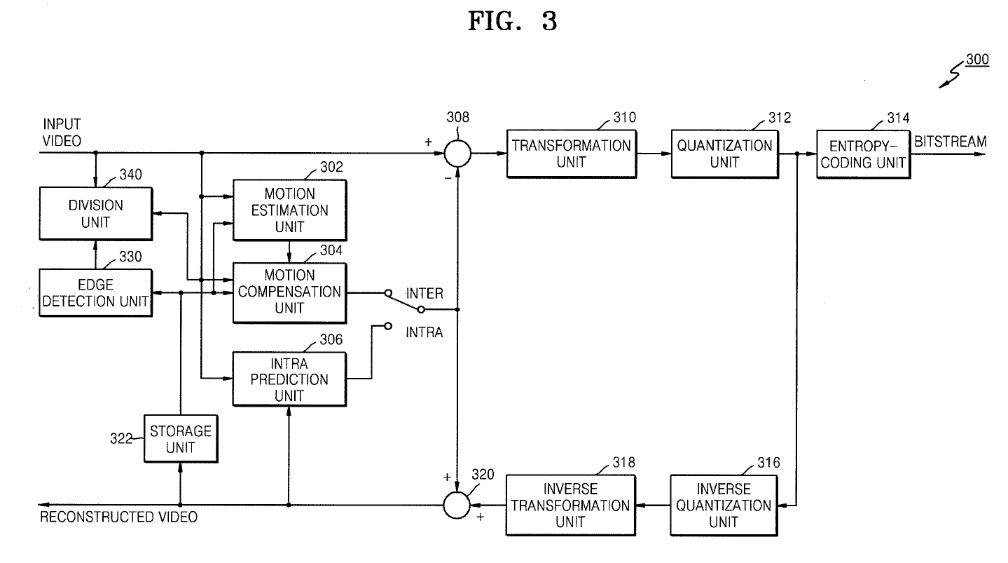

FIG. 3 is a block diagram of a video encoding apparatus 300 according to an exemplary embodiment of the present invention.

Referring to FIG. 3, the video encoding apparatus 300 includes a motion estimation unit 302, a motion compensation unit 304, an intraprediction unit 306, a subtraction unit 308, a transformation unit 310, a quantization unit 312, an entropy-coding unit 314, an inverse quantization unit 316, an inverse transformation unit 318, an addition unit 320, a storage unit 322, an edge detection unit 330, and a division unit 340.

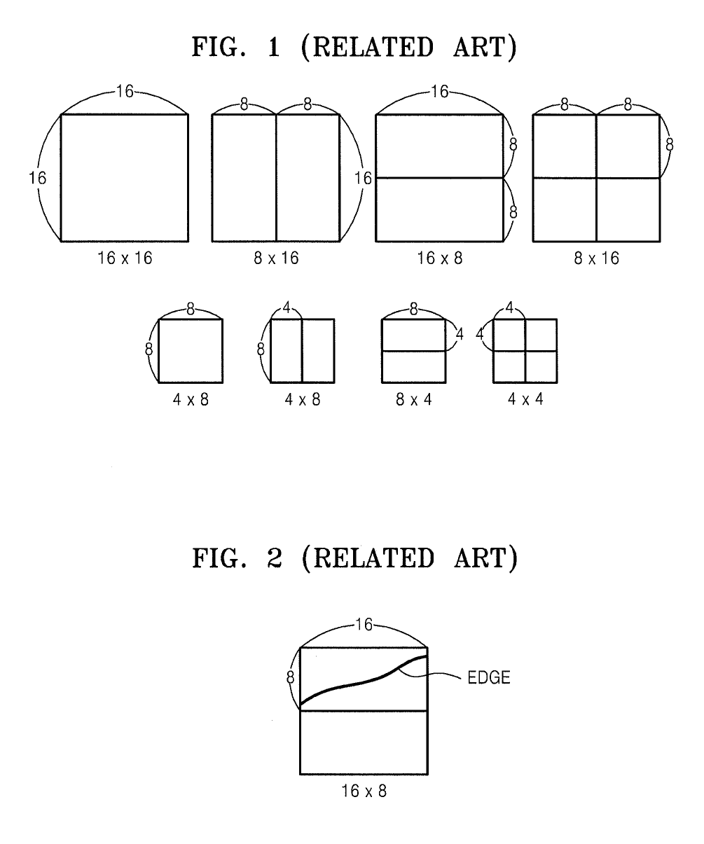

The motion estimation unit 302 and the motion compensation unit 304 perform motion estimation/compensation using data of a previous frame stored in the storage unit 322, thereby generating a prediction block. In particular, the motion estimation unit 302 and the motion compensation unit 304 perform motion estimation/compensation on each of a plurality of partitions generated by dividing a current block, using pixels belonging to an edge among neighboring pixels of the current block, in order to generate a prediction block as well as performing motion estimation/compensation on each of a plurality of fixed-shape partitions as illustrated in FIG. 1. The pixels belonging to the edge among the neighboring pixels of the current block are detected by the edge detection unit 330, and the division unit 340 divides the current block into a plurality of partitions using the detected neighboring pixels belonging to the edge.

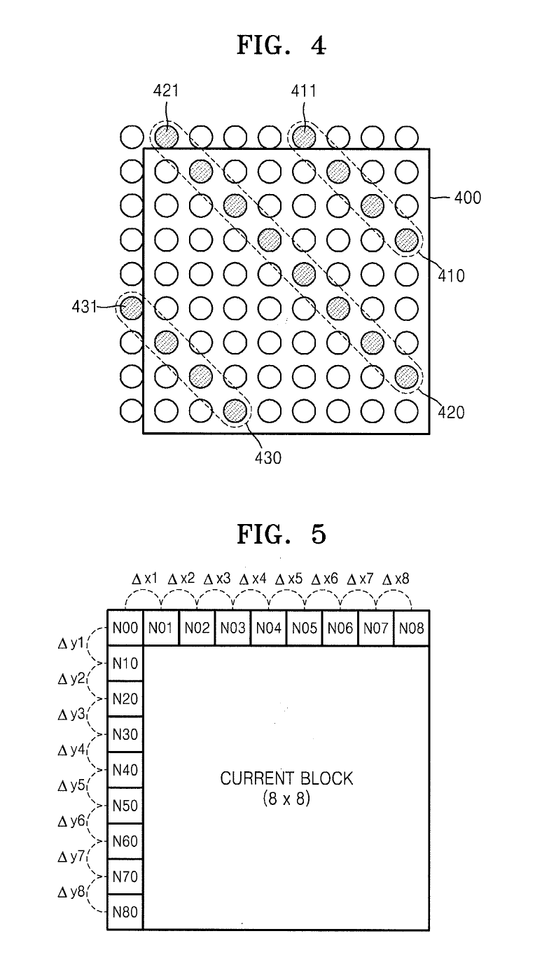

FIG. 4 is a view for explaining an example of division of a current block 400 using neighboring pixels belonging to edges of the current block 400, according to an exemplary embodiment of the present invention. Although the current block 400 has an 8×8 size in FIG. 4, the present invention is not limited thereto and the current block 400 may have a different size such as a 16×16 size or a 4×4 size.

Referring to FIG. 4, pixels 411, 421, and 431 belonging to edges of the current block 400 are detected from among previously encoded and reconstructed neighboring pixels that are adjacent to the current block 400 based on continuity of the edges, thereby predicting edges 410, 420, and 430 in the current block 400. In the current exemplary embodiment, the edge detection unit 330 detects discontinuous pixels from among the neighboring pixels, thereby detecting the pixels 411, 421, and 431 belonging to the edges 410, 420, and 430. In order to detect the pixels 411, 421, and 431 belonging to the edges 410, 420, and 430 from among the neighboring pixels, a difference between pixel values of the neighboring pixels may be calculated or a well-known edge detection algorithm such as a sobel algorithm may be used.

FIG. 5 is a view for explaining an example of detection of pixels belonging to an edge of a current block from among neighboring pixels that are adjacent to the current block, according to an exemplary embodiment of the present invention. In FIG. 5, N00 through N08 and N10 through N80 indicate pixel values of neighboring pixels that are adjacent to the current block.

Referring to FIG. 5, in order to detect pixels belonging to an edge of the current block from among neighboring pixels, the edge detection unit 330 calculates a difference between pixel values of consecutive neighboring pixels and determines neighboring pixels as belonging to the edge of the current block if the difference is greater than a predetermined threshold value. More specifically, the edge detection unit 330 calculates a difference Δx(a+1) between consecutive pixels N0a and N0(a+1) (where a=0, . . . , 8) among neighboring pixels located above the current block and a difference Δy(b+1) between consecutive pixels N[b*10] and N[(b+1)*10] (where b=0, . . . , 8) among neighboring pixels located to the left of the current block. The edge detection unit 330 detects the neighboring pixels corresponding to Δx(a+1) and Δy(b+1) that are greater than a predetermined threshold Th, thereby determining the neighboring pixels that are likely to be located near the edge. This is because the edge is discontinuous with respect to a surrounding area and thus pixels belonging to the edge have much different pixel values than those of their surrounding pixels.

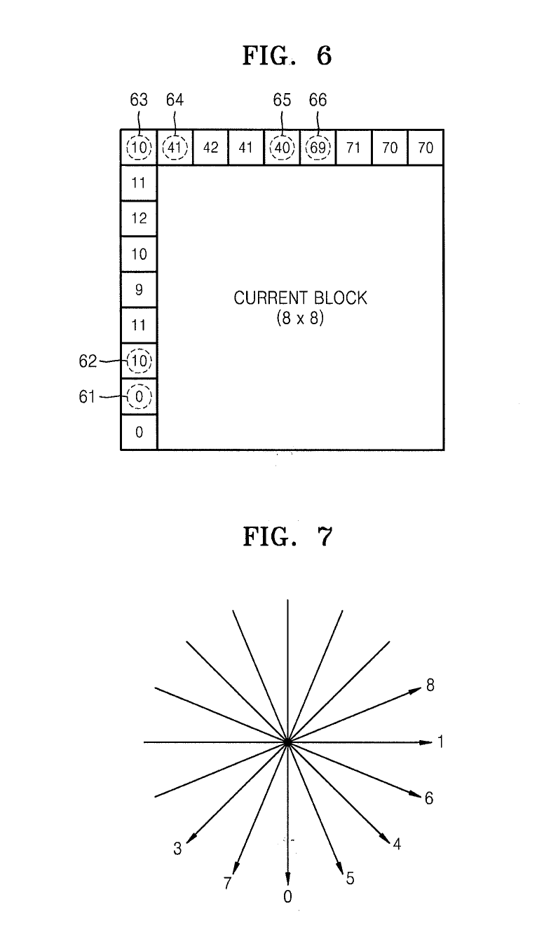

FIG. 6 is a view for explaining an example of detection of pixels belonging to an edge of a current block using neighboring pixels of the current block, according to an exemplary embodiment of the present invention. In FIG. 6, each of a plurality of small blocks indicates a neighboring pixel around the 8×8 current block and a number in each of the small blocks indicates a pixel value of the neighboring pixel. It is assumed that the predetermined threshold value Th with respect to a pixel value difference for determining discontinuity between consecutive pixels is 9.

Referring to FIG. 6, a difference between pixel values of consecutive neighboring pixels 61 and 62 around the current block is 10, a difference between pixel values of consecutive neighboring pixels 63 and 64 around the current block is 31, a difference between pixel values of consecutive neighboring pixels 65 and 66 around the current block is 29. These differences are greater than the threshold value Th of 9. In this way, the edge detection unit 330 calculates differences between pixel values of consecutive neighboring pixels around the current block, thereby detecting discontinuous pixels 61, 62, 63, 64, 65, and 66 belonging to edges from among the neighboring pixels around the current block.

Once the edge detection unit 330 detects neighboring pixels belonging to edges, the division unit 340 divides the current block along a predetermined-direction line passing through the neighboring pixels belonging to the edges. The predetermined-direction line may be expressed as a polynomial function f(x)=a0×n+a1×n−1+ . . . an (where n is an integer greater than 1). Although a block is divided along a straight line expressed as a linear function in the following description, it may be divided along a line expressed as a polynomial function, considering that an edge is not in a straight-line form.

FIG. 7 illustrates edge directions used for division of a current block, according to an exemplary embodiment of the present invention.

As described above, it may be predicted that an edge in a current block is located near a predetermined-direction straight line passing through pixels determined as belonging to the edge among neighboring pixels of the current block. The predetermined direction of the straight line passing through the pixels belonging to the edge may be selected from among predefined prediction directions. For example, the predetermined direction of the straight line may be one of 8 intraprediction directions among directions of 4×4-block intraprediction modes except for a direct current (DC) mode according to the H.264 standard. In other words, referring to FIG. 7, the division unit 340 may divide the current block in a direction of a prediction mode selected from among a vertical mode (mode 0), a horizontal mode (mode 1), a diagonal down-left mode (mode 3), a diagonal down-right mode (mode 4), a vertical right mode (mode 5), a horizontal-down mode (mode 6), a vertical left mode (mode 7), and a horizontal-up mode (mode 8).

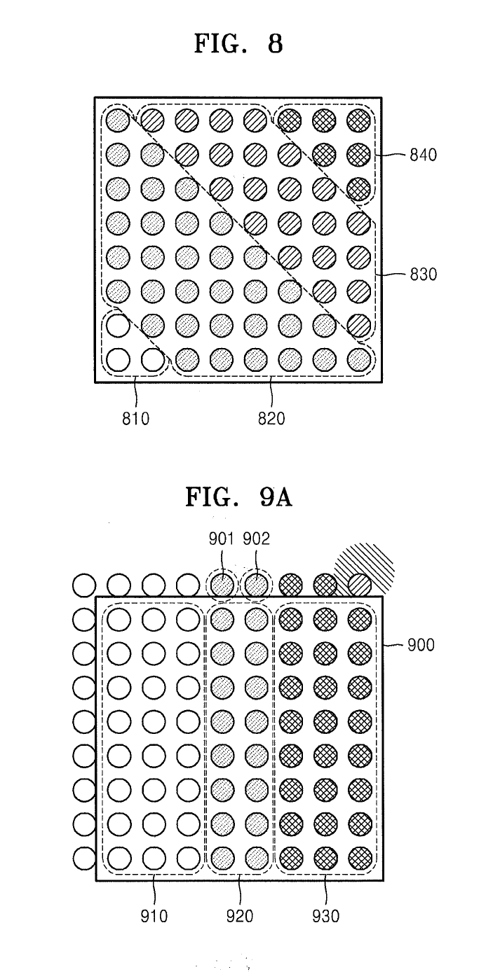

FIG. 8 is a view for explaining an example of division of a current block using detected neighboring pixels belonging to an edge of the current block as illustrated in FIG. 6, according to an exemplary embodiment of the present invention.

As mentioned above, once the discontinuous pixels 61, 62, 63, 64, 65, and 66 belonging to the edges are detected using the neighboring pixels illustrated in FIG. 6, the division unit 340 determines that the edge exists around the pixels 61, 62, 63, 64, 65, and 66 which are adjacent to the current block and belong to the edges, selects one of the prediction directions illustrated in FIG. 7, and divides the current block in the selected prediction direction. In FIG. 8, the current block is divided into four partitions 810, 820, 830, and 840 on the assumption that the selected prediction direction is mode 4 illustrated in FIG. 7. Although the current block is divided in a prediction direction corresponding to mode 4 among the 8 intraprediction directions in FIG. 8, the present invention is not limited thereto and the current block may also be divided in other directions. A final prediction direction for dividing the current block is determined by encoding partitions obtained by dividing the current block in different directions with respect to neighboring pixels included in edges of the current block and comparing costs of generated bitstreams.

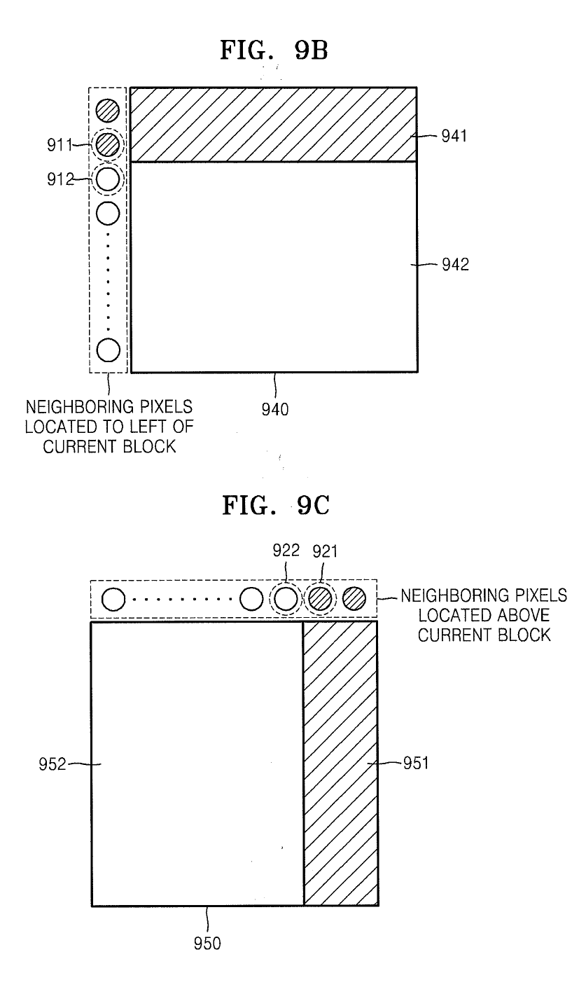

FIGS. 9A to 9C illustrate other examples of division of a current block using neighboring pixels belonging to an edge of the current block, according to exemplary embodiments of the present invention.

In FIG. 9A, when pixels 901 and 902 belonging to an edge of a current block 900 are detected from among neighboring pixels of the current block 900, the current block 900 is divided into 3 partitions 910, 920, and 930 in a vertical direction with respect to the pixels 901 and 902 belonging to the edge.

In FIGS. 9B and 9C, pixels belonging to an edge of a current block 940 are detected from among only neighboring pixels that are located to the left of the current block 940 and neighboring pixels located above the current block 940 in order to reduce the amount of computation, and the current block 940 is divided using the detected pixels belonging to the edge of the current block 940.

Referring to FIG. 9B, when neighboring pixels 911 and 912 among neighboring pixels located to the left of the current block 940 are discontinuous with each other, it is determined that an edge exists between the neighboring pixels 911 and 912 and thus the current block 940 is divided into 2 partitions 941 and 942 in a horizontal direction. Such a division process may be additionally performed in order to predict a block mode in more detail when a current block is predicted in a 16×8 prediction mode using a conventional block mode determination process. In other words, when a current block is predicted in the 16×8 prediction mode using a conventional block mode determination process, discontinuous pixels among neighboring pixels located to the left of the current block are additionally determined and the current block is divided along a straight line passing between the discontinuous pixels, thereby determining a final block prediction mode.

Similarly, referring to FIG. 9C, when neighboring pixels 921 and 922 among neighboring pixels located above a current block 950 are discontinuous with each other, it is determined that an edge exists between the neighboring pixels 921 and 922 and thus the current block 950 is divided into 2 partitions 951 and 952 in a vertical direction. Such a division process may be additionally performed in order to predict a block mode in more detail when a current block is predicted in an 8×16 prediction mode using a conventional block mode determination process.

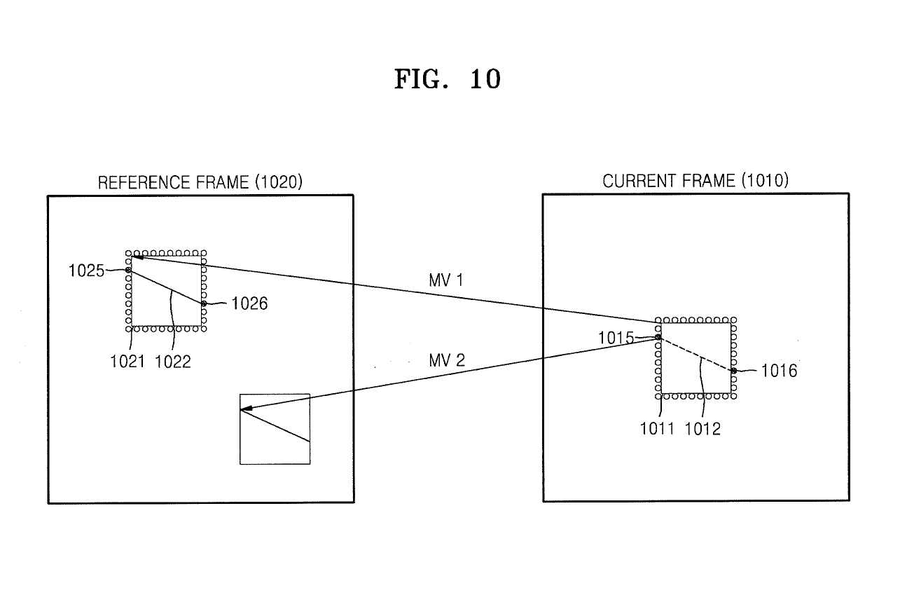

FIG. 10 is a view for explaining another example of detection of pixels belonging to an edge of a current block 1011 from among neighboring pixels that are adjacent to the current block 1011, according to an exemplary embodiment of the present invention.

Referring to FIG. 10, the edge detection unit 330 may detect pixels belonging to an edge of the current block 1011 among neighboring pixels around the current block 1011 using neighboring pixels around a corresponding region 1021 of a reference frame 1020, which is indicated by a motion vector generated by motion estimation with respect to the current block 1011, instead of detecting the pixels belonging to the edge of the current block 1011 by directly using the neighboring pixels around the current block 1011. More specifically, the edge detection unit 330 detects pixels belonging to an edge 1022 in the corresponding region 1021 of the reference frame 1020 by calculating a difference between pixel values of every two consecutive pixels among the neighboring pixels around the corresponding region 1021 of the reference frame 1020, or by applying the sobel algorithm to the neighboring pixels around the corresponding region 1021 of the reference frame 1020 as described above. The edge detection unit 330 then determines neighboring pixels around the current block 1011 that correspond to the detected pixels belonging to the edge 1022 of the reference frame 1020, as belonging to the edge in the current block 1011. For example, as illustrated in FIG. 10, if the edge detection unit 330 determines that pixels 1025 and 1026 marked with dark circles among the neighboring pixels around the corresponding region 1021 belong to the edge 1022, it may determine that pixels 1015 and 1016 marked with dark circles among the neighboring pixels around the current block 1011 belong to the edge of the current block 1011 based on a relative position relationship between the current block 1011 and its corresponding region 1021. The division unit 340 then divides the current block 1011 into partitions along a predetermined-direction straight line 1012 passing through the pixels 1015 and 1016 belonging to the edge in the current block 1011.

Referring back to FIG. 3, the motion estimation unit 302 performs motion estimation on the divided partitions of the current block, thereby generating motion vectors. The motion estimation unit 302 may perform motion estimation on each of the partitions in order to generate a motion vector for each of the partitions because pixels in the same block may have different video characteristics along the edge. In FIG. 10, for an upper partition of the current block 1011, a corresponding region of the reference frame 1020, which is indicated by a previous motion vector MV1, may be used as a prediction value or a prediction value may be generated by a separate motion estimation process after edge detection. For a lower partition of the current block 1011, a corresponding region of the reference frame 1020, which is indicated by the previous motion vector MV1, may be used as a prediction value or a prediction value may be generated using a new motion vector MV2 generated by a separate motion estimation process after edge detection. Although the two partitions of the current block 1011 use the same reference frame 1020 in FIG. 10, they may also be motion-estimated/compensated using different reference frames.

The motion compensation unit 304 generates a prediction partition for each of the partitions of the current block by obtaining a corresponding region of the reference frame, which is indicated by the motion vector of each of the partitions.

The intraprediction unit 306 performs intraprediction by searching in the current frame for a prediction block of the current block.

Upon the generation of the prediction partition for each of the partitions of the current block by motion estimation/compensation, the subtraction unit 308 generates residual partitions by subtracting the prediction partitions from the original partition.

The transformation unit 310 performs discrete cosine transformation (DCT) on a residual block that is obtained by combining the residual partitions or on each of the residual partitions, and the quantization unit 312 performs quantization on DCT coefficients for compression. The entropy-coding unit 314 performs entropy-coding on the quantized DCT coefficients, thereby generating a bitstream.

The inverse quantization unit 316 and the inverse transformation unit 318 perform inverse quantization and inverse transformation on quantized video data. The addition unit 320 adds the inversely transformation video data to predicted video data, thereby reconstructing the original video data. The reconstructed video data is stored in the storage unit 322 in order to be used as reference video data for prediction of a next frame.

The video encoding apparatus 300 according to the exemplary embodiment of the present invention described with reference to FIG. 3, encodes partitions generated by dividing the current block along a straight line oriented in a previously selected direction in order to generate a first bitstream, encodes partitions generated by dividing the current block along a straight line oriented in a different direction from the previously selected direction in order to generate a second bitstream, compares costs of the first and second bitstreams and selects a final partition mode for the current block. Here, cost calculation may be performed using various cost functions such as a sum of absolute difference (SAD) function, a sum of absolute transformed difference (SATD) function, a sum of squared difference (SSD) function, a mean of absolute difference (MAD) function, a Lagrange function, etc.

Information on the selected final partition mode is inserted into a header of a bitstream in order to be used by a decoding apparatus to reconstruct the current block. The information on the selected final partition mode, which is inserted into the header of the bitstream, may include information on positions of pixels belonging to an edge of the current block from among neighboring pixels around the current block and information on a polynomial function for expressing a line used to divide the current block. The information on the polynomial function may include the degree of the polynomial function and a coefficient of the polynomial function. The information on the selected final partition mode may be inserted into the bitstream instead of information on a division mode of the current block, which is conventionally inserted. As described with reference to FIG. 10, when pixels belonging to an edge of a current block are detected using neighboring pixels around a corresponding region of a reference frame, which is indicated by a motion vector of the current block, the video encoding apparatus 300 transmits information on the motion vector of the current block to a decoding apparatus without transmitting information on positions of neighboring pixels belonging to an edge in the corresponding region. Thereafter, the decoding apparatus may detect pixels belonging to an edge from among neighboring pixels around the current block using the same process as an edge detection process performed in the video encoding apparatus 300 and decode partitions generated by dividing the current block using the detected pixels.

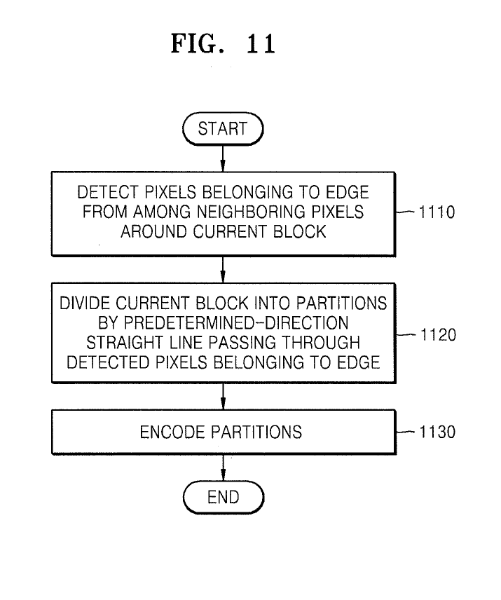

FIG. 11 is a flowchart of a video encoding method according to an exemplary embodiment of the present invention.

Referring to FIG. 11, pixels belonging to an edge of a current block are detected from among neighboring pixels that are adjacent to the current block to be encoded, in operation 1110. As previously described, the pixels belonging to the edge of the current block may be detected by calculating a difference between pixel values of consecutive neighboring pixels and determining the neighboring pixels as belonging to the edge, if the difference is greater than a predetermined threshold value or by using an algorithm such as a sobel algorithm.

In operation 1120, the current block is divided into partitions along a predetermined-direction straight line passing through the detected pixels belonging to the edge of the current block.

In operation 1130, motion estimation/compensation is performed on each of the partitions in order to generate a prediction partition, and generated prediction partitions are quantized and entropy-encoded in order to generate a bitstream. Next, the current block is divided into partitions along a straight line oriented in a different direction than the direction selected in operation 1120 and operation 1130 is repeated. Costs of bitstreams generated using the partitions obtained by dividing the current block by the straight lines oriented in the different directions are compared with each other, thereby determining a final partition mode. Information on the final partition mode is inserted into a header of a bitstream in order to be used by a decoding apparatus to decode the current block.

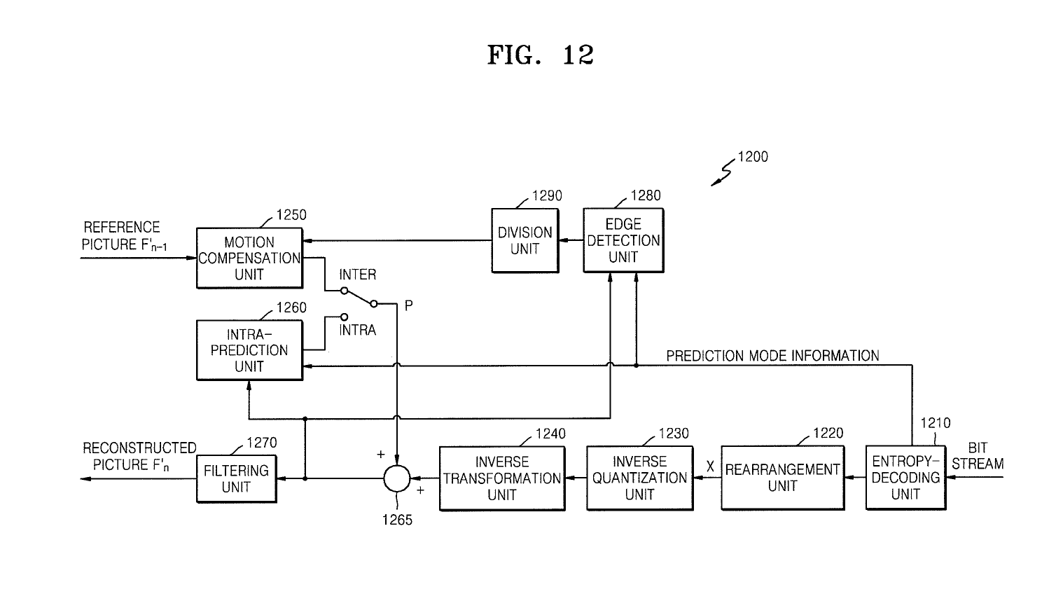

FIG. 12 is a block diagram of a video decoding apparatus 1200 according to an exemplary embodiment of the present invention.

Referring to FIG. 12, the video decoding apparatus 1200 includes an entropy-decoding unit 1210, a rearrangement unit 1220, an inverse quantization unit 1230, an inverse transformation unit 1240, a motion compensation unit 1250, an intraprediction unit 1260, an addition unit 1265, a filtering unit 1270, an edge detection unit 1280, and a division unit 1290.

The entropy-decoding unit 1210 receives a compressed bitstream and generates quantized coefficients by entropy-decoding the received bitstream. The rearrangement unit 1220 rearranges the quantized coefficients. The inverse quantization unit 1230 and the inverse transformation unit 1240 perform inverse quantization and inverse transformation on the quantized coefficients, thereby reconstructing a residual block or residual partitions.

The edge detection unit 1280 extracts prediction mode information including information on positions of pixels belonging to an edge of a current block to be decoded and information on a line that divides the current block into partitions from the received bitstream. If the received bitstream has been encoded by detecting the pixels belonging to the edge using a motion vector of the current block as illustrated in FIG. 10, the edge detection unit 1280 extracts information on the motion vector of the current block from the bitstream, detects pixels belonging to an edge of the current block from among neighboring pixels around a corresponding block of a previously decoded reference frame, which is indicated by the motion vector of the current block, and determines pixels of the current block, which correspond to the detected pixels belonging to the edge in the corresponding block of the reference frame, as belonging to the edge in the current block.

The division unit 1290 divides the current block into partitions using the detected pixels belonging to the edge, and the extracted information on the line that divides the current block.

The motion compensation unit 1250 performs motion compensation on the divided partitions, thereby generating prediction partitions.

The addition unit 1265 adds the prediction partitions to the residual partitions, thereby reconstructing the original partitions. The current block is thus decoded by combining the reconstructed partitions.

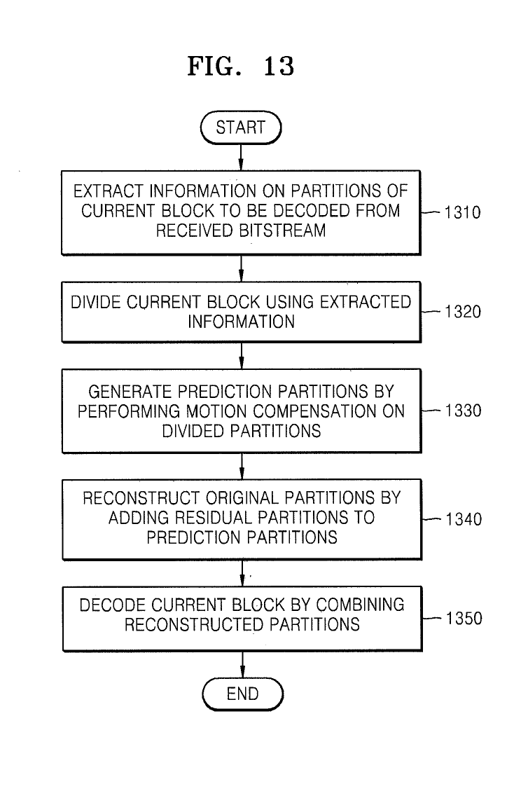

FIG. 13 is a flowchart of a video decoding method according to an exemplary embodiment of the present invention.

Referring to FIG. 13, information on pixels belonging to an edge of a current block to be decoded and information on a line that divides the current block are extracted from a received bitstream in operation 1310.

In operation 1320, the current block is divided into partitions using the extracted information on the pixels belonging to the edge and the extracted information on the line that divides the current block.

In operation 1330, motion compensation is performed on the divided partitions, thereby generating prediction partitions.

In operation 1340, residual partitions included in the bitstream are reconstructed and added to the prediction partitions, thereby reconstructing the original partitions.

In operation 1350, the reconstructed partitions are combined in order to decode the current block.

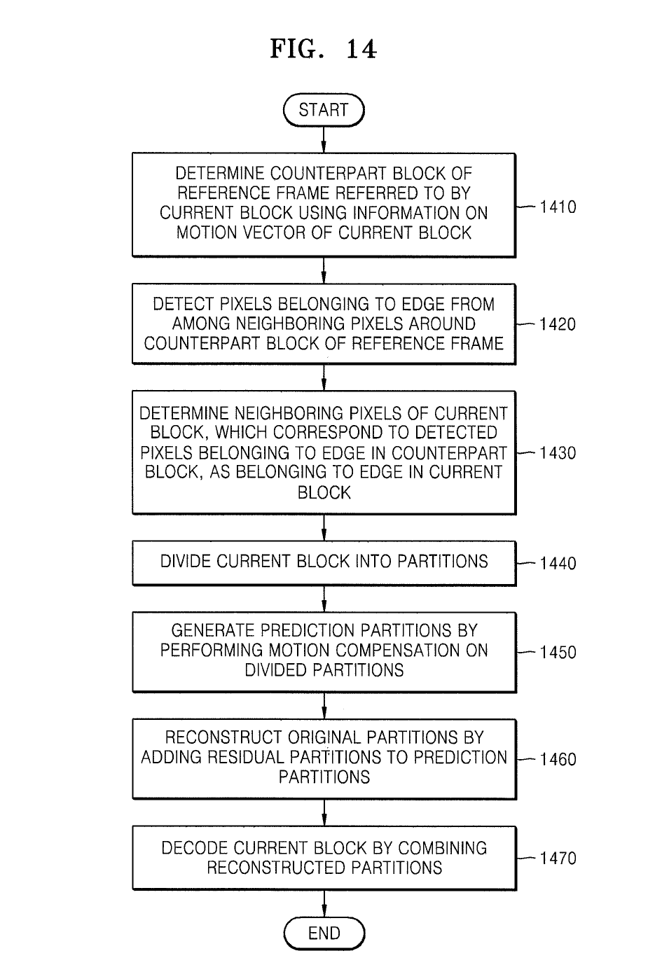

FIG. 14 is a flowchart of a video decoding method according to another exemplary embodiment of the present invention.

Referring to FIG. 14, a corresponding block of a reference frame, which is referred to by a current block to be decoded, is determined using information on a motion vector of the current block in operation 1410.

In operation 1420, pixels belonging to an edge of the corresponding block are detected from among neighboring pixels around the determined corresponding block of the reference frame. The pixels belonging to the edge of the corresponding block may be detected by calculating a difference between pixel values of consecutive neighboring pixels and determining neighboring pixels as belonging to the edge of the corresponding block, if the difference is greater than a predetermined threshold value or by using an algorithm such as the sobel algorithm.

In operation 1430, neighboring pixels of the current block, which correspond to the detected pixels belonging to the edge in the corresponding block of the reference frame, are determined as belonging to the edge in the current block.

In operation 1440, the neighboring pixels belonging to the edge in the current block are connected in order to divide the current block into partitions.

In operation 1450, motion compensation is performed on the partitions using information on motion vectors of the partitions, which is included in the bitstream, thereby generating prediction partitions.

In operation 1460, residual partitions included in the bitstream are reconstructed and then are added to the prediction partitions, thereby reconstructing the original partitions.

In operation 1470, the reconstructed partitions are combined in order to decode the current block.

An exemplary embodiment of the present invention can be embodied as a computer-readable program recorded on a computer-readable recording medium. The computer-readable recording medium may be any data storage device that can store data which can be thereafter read by a computer system. Examples of computer-readable recording media include read-only memory (ROM), random-access memory (RAM), CD-ROMs, magnetic tapes, floppy disks, optical data storage devices, and carrier waves. The computer-readable recording medium can also be distributed over network of coupled computer systems so that the computer-readable code is stored and executed in a decentralized fashion.

As described above, according to exemplary embodiments of the present invention, video encoding efficiency can be improved by encoding partitions that are obtained by dividing a block based on an edge in the block, instead of encoding fixed-shape blocks.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A video encoding method comprising:
detecting pixels belonging to an edge from among neighboring pixels that are adjacent to a current block to be encoded;
dividing the current block into partitions along a line that passes through the detected pixels belonging to the edge, wherein the line is expressed as a predetermined polynomial function; and
encoding the divided partitions of the current block.

2. The video encoding method of claim 1, wherein the detecting the pixels belonging to the edge comprises calculating a difference between pixel values of two consecutive pixels among the neighboring pixels, and determining neighboring pixels belonging to the edge of the current block if the difference is greater than a predetermined threshold.

3. The video encoding method of claim 1, wherein the detecting the pixels belonging to the edge comprises using a sobel algorithm.

4. The video encoding method of claim 1, wherein the detecting the pixels belonging to the edge comprises:
determining a corresponding block of a reference frame referred to by the current block by performing interprediction on the current block;
detecting pixels belonging to an edge from among neighboring pixels that are adjacent to the determined corresponding block; and
determining neighboring pixels around the current block, which correspond to the detected pixels of the determined corresponding block, as belonging to the edge.

5. The video encoding method of claim 1, wherein the dividing the current block comprises dividing the current block along a straight line oriented in a direction selected from among at least one predefined prediction direction with respect to the pixels belonging to the edge.

6. The video encoding method of claim 1, wherein the encoding the divided partitions comprises:
performing motion estimation and compensation on the divided partitions of the current block, thereby generating prediction partitions;
performing transformation, quantization, and entropy-coding on differential values between the prediction partitions and the divided partitions, thereby generating a bitstream;
selecting a final partition mode of the current block by comparing costs of bitstreams generated using partitions obtained by dividing the current block by lines expressed as different polynomial functions; and
storing information on the selected final partition mode in a predetermined region of the generated bitstream.

7. The video encoding method of claim 6, wherein the information on the final partition mode comprises information on positions of the pixels belonging to the edge among neighboring pixels that are adjacent to the current block and information on the polynomial function corresponding to the selected partition mode.

8. The video encoding method of claim 1, wherein the neighboring pixels that are adjacent to the current block comprise at least one of neighboring pixels located above the current block, neighboring pixels located to the left of the current block, and neighboring pixels located above and to the left of the current block.

9. A video encoding apparatus comprising:
an edge detection unit that detects pixels belonging to an edge from among neighboring pixels that are adjacent to a current block to be encoded;
a division unit that divides the current block into partitions along a line that passes through the detected pixels belonging to the edge of the current block, wherein the line is expressed as a predetermined polynomial function; and
an encoding unit that encodes the divided partitions of the current block.

10. The video encoding apparatus of claim 9, wherein the edge detection unit calculates a difference between pixel values of two consecutive pixels among the neighboring pixels around the current block, and determines the neighboring pixels as belonging to the edge of the current block if the difference is greater than a predetermined threshold.

11. The video encoding apparatus of claim 9, wherein the edge detection unit uses a sobel algorithm.

12. The video encoding apparatus of claim 9, further comprising a motion estimation unit that determines a corresponding block of a reference frame referred to by the current block by performing interprediction on the current block,
wherein the edge detection unit detects pixels belonging to an edge from among neighboring pixels that are adjacent to the corresponding block and determines neighboring pixels around the current block, which correspond to the detected pixels of the corresponding block, as belonging to the edge in the current block.

13. The video encoding apparatus of claim 9, wherein the division unit divides the current block along a straight line oriented in a direction selected from among at least one predefined prediction direction with respect to the pixels belonging to the edge around the current block.

14. The video encoding apparatus of claim 9, wherein the encoding unit comprises:
a motion estimation and compensation unit that performs motion estimation and compensation on the divided partitions of the current block to generate prediction partitions;
a bitstream generation unit that performs transformation, quantization, and entropy-coding on differential values between the prediction partitions and the divided partitions, thereby generating a bitstream; and
a mode determination unit that selects a final partition mode of the current block by comparing costs of bitstreams generated using partitions obtained by dividing the current block by lines expressed as different polynomial functions,
wherein the bitstream generation unit stores information on the selected final partition mode in a predetermined region of the generated bitstream.

15. The video encoding apparatus of claim 14, wherein the information on the final partition mode comprises information on positions of the pixels belonging to the edge around the current block and information on the direction of the straight line.

16. The video encoding apparatus of claim 9, wherein the neighboring pixels that are adjacent to the current block comprise at least one of neighboring pixels located above the current block, neighboring pixels located to the left of the current block, and neighboring pixels located above and to the left of the current block.

17. A video decoding method comprising:
extracting information on positions of pixels belonging to an edge from among neighboring pixels that are adjacent to a current block and information on a line that passes through the pixels belonging to the edge and which divides the current block, from a received bitstream;
dividing the current block into partitions using the extracted information on the positions of the pixels belonging to the edge of the current block and the extracted information on the line;
performing motion compensation on the divided partitions to generating prediction partitions;
adding the prediction partitions to a residue included in the bitstream, thereby reconstructing the partitions of the current block; and
combining the reconstructed partitions, thereby decoding the current block.

18. A video decoding method comprising:
determining a corresponding block of a reference frame referred to by a current block to be decoded using information on a motion vector of the current block;
detecting pixels belonging to an edge of the determined corresponding block from among neighboring pixels that are adjacent to the determined corresponding block;
determining neighboring pixels that are adjacent to the current block and which correspond to the detected pixels of the determined corresponding block, as belonging to an edge of the current block;
dividing the current block into partitions along the determined neighboring pixels belonging to the edge of the current block;
performing motion compensation on the divided partitions using information on motion vectors of the divided partitions that is included in the bitstream, thereby generating prediction partitions;
adding the prediction partitions to a residue included in the bitstream, thereby reconstructing the partitions of the current block; and
combining the reconstructed partitions, thereby decoding the current block.

19. A video decoding apparatus comprising:
an edge detection unit that extracts information on positions of pixels belonging to an edge from among neighboring pixels that are adjacent to a current block and information on a line that passes through the pixels belonging to the edge and divides the current block, wherein the edge detection unit extracts the information from a received bitstream;
a division unit that divides the current block into partitions using the extracted information on the positions of the pixels belonging to the edge and the extracted information on the line;
a motion compensation unit that performs motion compensation on the divided partitions, thereby generating prediction partitions;
an addition unit that adds the prediction partitions to a residue included in the received bitstream, thereby reconstructing the partitions of the current block; and
a combination unit that combines the reconstructed partitions, thereby decoding the current block.

20. A video decoding apparatus comprising:
an edge detection unit that determines a corresponding block of a reference frame referred to by a current block to be decoded, using information on a motion vector of the current block, detects pixels belonging to an edge around the determined corresponding block from among neighboring pixels that are adjacent to the determined corresponding block, and determines neighboring pixels that are adjacent to the current block and which correspond to the detected pixels of the corresponding block, as belonging to an edge around the current block;
a division unit that divides the current block into partitions along the determined neighboring pixels belonging to the edge around the current block;
a motion compensation unit that performs motion compensation on the divided partitions using information on motion vectors of the divided partitions, the information being included in the bitstream, thereby generating prediction partitions;
an addition unit that adds the prediction partitions to a residue included in the bitstream, thereby reconstructing the partitions of the current block; and
a combining unit that combines the reconstructed partitions, thereby decoding the current block.
